(19) United States
(12) Patent Application Publication
(10) Pub. No.: US 2010/0284645 A1
(43) Pub. Date: Nov. 11, 2010

(54) SEMICONDUCTOR THERMOOPTIC PHASE SHIFTER

(75) Inventor: Christopher R. Doerr, Middletown, NJ (US)

Correspondence Address: HITT GAINES, PC;ALCATEL-LUCENT, PO BOX 832570, RICHARDSON, TX, 75083, US

(73) Assignee: Alcatel-Lucent USA Inc., Murray Hill, NJ (US)

(21) Appl. No.: 12/464,389

(22) Filed: May 12, 2009

Related U.S. Application Data
(60) Provisional application No. 61/176,367, filed on May 7, 2009.

(51) Int. Cl. G02F 1/035; G02B 6/036; G02B 6/26

(52) U.S. Cl. 385/3; 385/126; 385/40; 385/16

(57) ABSTRACT

An optical device comprising a waveguide on a planar substrate. The waveguide includes a semi-conductive cladding layer that contacts electrical leads which are coupleable an electrical power source for controlling a refractive index of the cladding layer by passing electrical power through the cladding layer.

### CROSS-REFERENCE TO RELATED APPLICATION

This application claims the benefit of U.S. Provisional Application Ser. No. 61/176,367, filed by Christopher R. Doerr on May 7, 2009, entitled “A SEMICONDUCTOR THERMOOPTIC PHASE SHIFTER,” commonly assigned with this application and incorporated herein by reference.

### TECHNICAL FIELD OF THE INVENTION

The present disclosure is directed, in general, to optical devices and more specifically, thermooptic phase shifting devices, and methods using and of manufacturing thereof.

### BACKGROUND OF THE INVENTION

This section introduces aspects that may be helpful to facilitating a better understanding of the inventions. Accordingly, the statements of this section are to be read in this light. The statements of this section are not to be understood as admissions about what is in the prior art or what is not in the prior art.

Wavelength Division Multiplexing (WDM) control devices, such as wavelength add-drops (WADs), wavelength selective cross connects (WSCs), and dynamic gain equalization filters (DGEFs), often consist of a demultiplexer and a multiplexer connected by an array of switches. A low-loss, compact, mass-produceable way to make the switches is to use a planar arrangement of thermo-optic Mach-Zehnder (M-Z) interferometer switches in silica waveguides. A thermooptic phase shifter can include a heating element located over the waveguide that causes the refractive index of the waveguide material to change via a temperature change when electrical power is sent through the heating element.

### SUMMARY OF THE INVENTION

One embodiment is an optical device. The device comprises a waveguide on a planar substrate. The waveguide includes a semi-conductive cladding layer that contacts electrical leads which are coupleable an electrical power source for controlling a refractive index of the cladding layer by passing electrical power through the cladding layer.

Another embodiment is a method of use. The method comprises optically switching an incoming light. Optical switching includes transmitting a first part of the incoming light to a first waveguide arm of a waveguide and transmitting a remaining second part of the incoming light to a second waveguide arm of the waveguide. Optically switching the incoming light also includes passing electrical power through electrical leads that contact at least one of the first or second waveguide arms, thereby causing a change in a refractive index of a cladding layer of the at least one of the first or second waveguide arms. The refractive index changes such that one or both of the first and second parts of light are phase-adjusted to be either substantially in-phase or substantially out-of-phase with each other. Optically switching the incoming light also includes optically combining the phase-adjusted first and second parts of light, wherein the first and second parts of light either constructively add or destructively cancel to produce an output light.

Another embodiment is a method of manufacture. The method comprises forming a waveguide on a planar substrate, the waveguide including a cladding layer. The method also includes forming electrical leads that directly contact the cladding layer. The electrical leads are coupleable to an electrical power source for controlling a refractive index of the cladding layer by passing electrical power through the cladding layer.

### BRIEF DESCRIPTION OF THE DRAWINGS

The embodiments of the disclosure are best understood from the following detailed description, when read with the accompanying FIGUREs. Corresponding or like numbers or characters indicate corresponding or like structures. Various features may not be drawn to scale and may be arbitrarily increased or reduced in size for clarity of discussion. Reference is now made to the following descriptions taken in conjunction with the accompanying drawings, in which:

FIGS. 1A and 1B present plan views of portions of different example optical devices;

FIG. 2 shows a cross-sectional detailed view of a portion of an optical device similar to that depicted in FIG. 1A;

FIG. 3 shows a detailed partial view of portions of an optical device similar to that depicted in FIG. 1A;

FIG. 4 shows a lower magnification view of an optical device similar to that depicted in FIG. 1A;

FIG. 5 presents a flow diagram of an example method of using an optical device such as depicted in FIGS. 1A-4; and

FIG. 6 presents a flow diagram of an example method of manufacturing an optical device such as depicted in FIGS. 1A-4.

### DETAILED DESCRIPTION

The heating element of the thermooptic phase shifter is often a metal layer located over the waveguide. The metal layer must be separated from the waveguide by a significant distance, or else the metal layer can cause high optical losses. This separation distance reduces the thermooptic efficiency of the phase shifter, thus requiring more electrical power to achieve the desired extent of phase shifting. Separate processing steps typically are used to deposit the metal layer, and to protect the metal layer from aging, by covering it with another material, such as an oxide, thereby further complicating and increasing the expense of optical device manufacture.

It was discovered that it is possible to use the semi-conductivity of the waveguide cladding layer as the heating element. This eliminates the expense and complication of depositing, patterning, insulating, and protecting a metal layer heating element. Additionally, because heat is generated in the waveguide cladding layer, which is adjacent to the waveguide core, the thermooptic phase shifter can be more power-efficient than thermooptic phase shifters using a remotely located metal layer heating element. Moreover, because the resistivity of a semi-conductive waveguide cladding layer is higher than a metal layer, it is possible to generate greater temperature increases, and hence greater optical phase shifts, as compared to a similar sized metal layer heating element to which the same amount of electrical power (e.g., a controlling voltage or current) is applied.

It was surprising that it was possible to use the waveguide cladding layer as a heating element, for at least two reasons. First, it was thought that applying an electrical current directly to the waveguide could generate free carriers which could cause optical losses because the free carriers could absorb significant amount of light being transmitted through the waveguide. However, experiments and theoretical calculations revealed that no significant increase in optical loss was observed, or was expected to occur, at the applied electrical currents likely to be used (e.g., about 100 mAmps or less). Second, there was concern that because the waveguide is embedded in an optical device such as a photonic integrated circuit, applying an electrical current to the waveguide cladding layer could cause other parts of the device to malfunction. However, it was discovered that the waveguide, and the leads that apply the electrical current to the waveguide, can be configured so that the extent of electrical current leakage into other parts of the device can be mitigated.

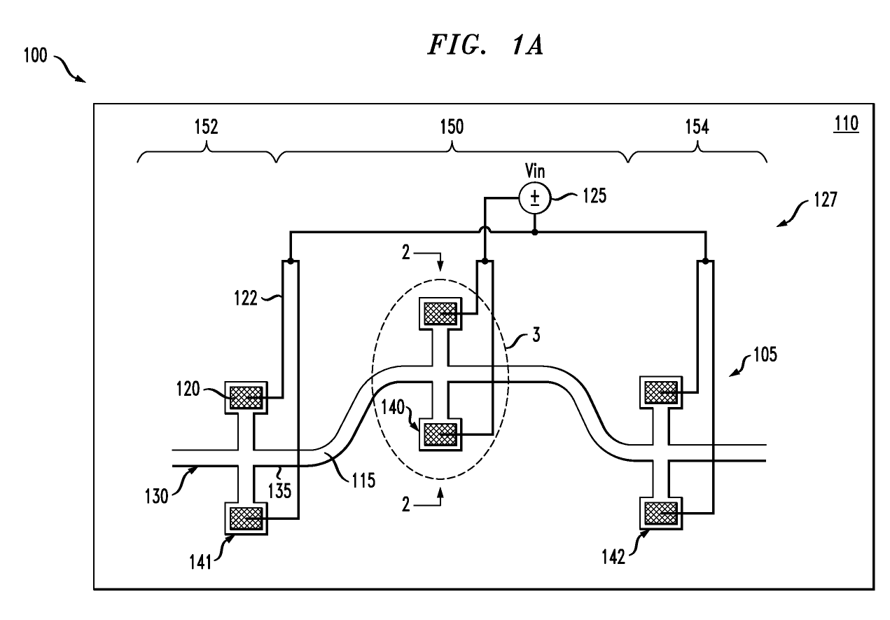

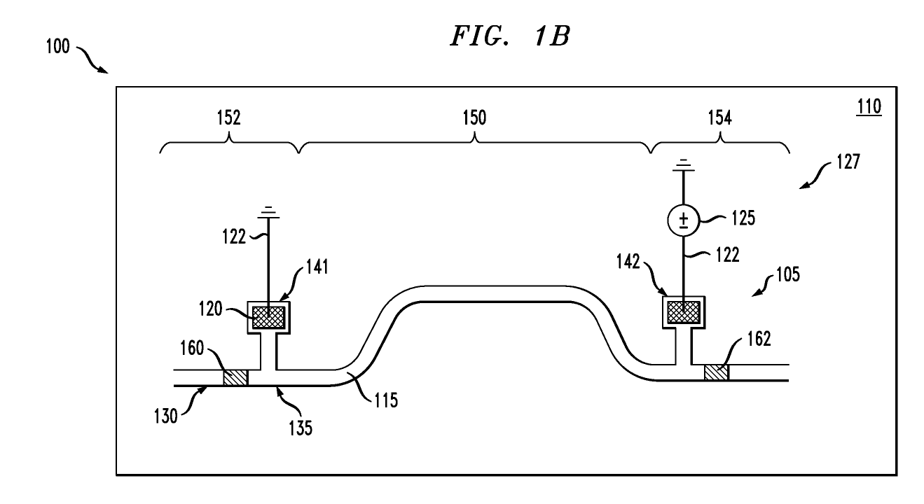

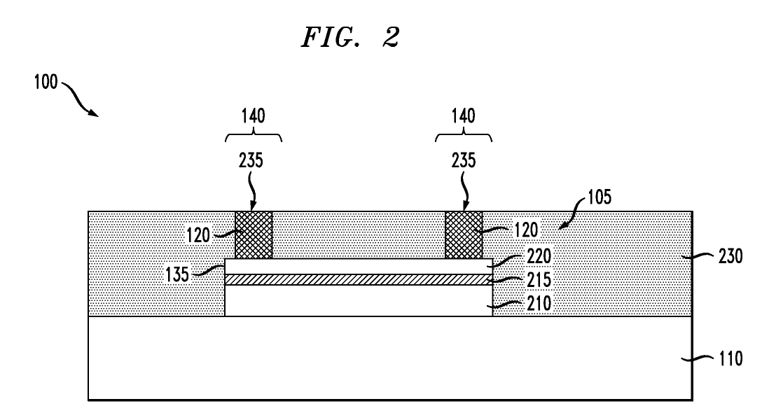

One embodiment is an optical device. FIG. 1A presents a plan view of an example optical device 100. FIG. 2 presents a cross-sectional view of a portion of the device along view line 2-2. FIG. 3 presents a detailed partial view of portions of the device similar to that presented in FIG. 1A, as indicated by reference circle 3. Overlying layers such as insulating layers, conductive lines, capacitors etc . . . , are sometimes not shown so that the underlying waveguide structure can be more clearly depicted.

Referring to FIGS. 1A-3 throughout, the device 100 comprises a waveguide 105 on a planar substrate 110. In some preferred embodiments, the waveguide 105 is a planar ridge waveguide (see e.g., FIG. 2). One skilled in the art would be familiar with the various types of ridge waveguide or other waveguide designs that could be used. The waveguide 105 includes a semi-conductive cladding layer 115 that contacts electrical leads 120. The cladding layer 115 can serve as a heating element for thermooptic switching. The leads 120 can be coupleable or are coupled, via conductive lines 122, to an electrical power source 125 for controlling a refractive index of the cladding layer 115 by passing electrical power through the cladding layer 115.

In some embodiments, the cladding layer 115 and the leads are part of a thermooptic switch 127 of the device 100, and the device 100 can be configured as a photonic integrated circuit device. For instance, the thermo-optic switch 127 can be, or include, a Mach-Zehnder interferometer of the photonic integrated circuit device 100.

As illustrated in FIG. 2, the waveguide 105 can include a lower cladding layer 210, a core layer 215 on the lower cladding layer and an upper cladding layer 220 on the core layer 215. The cladding layer 115 that contacts the leads 120 includes at least one of the lower cladding layer 210 or the upper cladding layer 220. In some cases, both the upper and lower cladding layers 210, 220 contact different ones of the leads 120.

In some cases, the cladding layer 115 of the main body 130 of the waveguide 105 (e.g., the light guiding and transmittable or transmitting part of the waveguide) directly contacts the leads 120. In such cases it can be desirable for the contacting lead 120 to be close to a lateral edge 135 of the waveguide 105 so as to minimize the optical losses associated with contacting the lead 120.

In other cases, to mitigate optical losses associated with contacting the lead 120, the waveguide 105 further includes one or more branching structures 140-142. Each branching structure 140-142 can include a continuous portion of the cladding layer 115 and act as the contact location for one of the leads 120.

As illustrated, the branching structures 140-142 can be a continuous portion of the cladding layer 115, and also be remote from the main body 130 of the waveguide 105. Having the branching structures 140-142 continuous with the cladding layer 115 facilitates the transfer of electrical power to or from the lead 120 to the cladding layer 115. Having the branching structures 140-142 remote from the waveguide 105 (e.g., the main body 130) helps reduce optical losses into the branching structures 140-142 of the waveguide 105.

Each branching structure 140 can include continuous portions of the lower cladding layer 210, core layer 215 and upper cladding layer 220 of the waveguide 105 (FIG. 2). For instance, as part of the process to form the waveguide 105, all of these layers 210, 215, 220 can be patterned to form the branching structures 140-142. In some cases the waveguide 105 includes a plurality of branching structures 140-142 that each include continuous portions of the same cladding layer 115 (e.g., the upper cladding layer 220) and each of the branching structures 140-142 is configured to contact different ones of the leads 120.

As illustrated in FIG. 3, in some embodiments, to minimize light losses into the branching structures, one or more the branching structure 140 extends substantially normal (e.g., about 90 degrees) to the waveguide 105. As depicted, two branching structure 140 can extend substantially normal and in opposite directions from the same portion of the waveguide 105.

To further reduce the extent of light losses, in some cases, one or more branching structure 140 can be angled away from the direction 305 of light transmission through the waveguide 105. For instance, in some cases, an exterior angle 310 between the branching structure 140 and the main body 130 of the waveguide 105 ranges from about 60 to less than about 90 degrees.

To minimize light losses and provide a sufficient area for contacting the lead 120, different portions of the branching structure 140 can have different sizes (e.g., lengths and/or widths). For instance, the branching structure 140 can include a first portion 315 adjacent to the waveguide 105 (e.g., the main body 130), and, a second portion 320. The second portion 320 can be continuously connected to the first portion 315 and be remote or tangential to the waveguide 105. The first portion 315 has a width 325 that is less than a width 330 of the second portion 320. The second portion 320 is configured to contact one of the leads 120.

To minimize light losses into the branching structure 140, some embodiments of the first portion 315 has a width 325 that is less than or equal to a width 335 of the main body 130 of the waveguide 105. For instance, in cases where the main body 130 has a width 335 of about 2.5 microns, the width 325 of the first portion 315 can be less than or equal to about 2.5 microns.

To minimize light losses into the branching structure 140, some embodiments of the first portion 315 have a length 340 that is at least about 5 times greater than the width 325 of the first portion 315. For instance, the length 340 can be about 10 microns or greater when the width 325 equals about 2 microns.

To provide a sufficient area for contacting the lead 120, in some embodiments, the second portion 320 has an area that is at least about 10 percent greater than an area of the contacting lead 120 (i.e., the lead 102 that the second portion 320 contacts). For instance, when the lead has an area of about 16 microns² (e.g., 4 microns by 4 microns), the area of the second portion equals about 17.6 microns² (e.g., a width 330 of about 4.2 microns by a length 345 of about 4.2 microns).

As noted above, it is desirable to configure the waveguide 105 so that the extent of electrical current leakage into other parts of the device 100 is minimized. In some embodiments, a central portion 150 of the waveguide 105 is configured to receive an input of the electrical power transmitted through one of the leads 120, and, ends of the waveguide 105 are configured to receive an output of the electrical power. For instance, as shown in FIG. 1A, a first branching structure 140 can be centrally located (e.g., in the central region 150) along the waveguide 105 and configured to receive the input of electrical power (e.g., control voltage, Vin) transmitted through one of the leads 120 through the at least a portion of the waveguide 105. Second and third branching structures 141, 142 can be located on opposite ends (e.g., input and output ends 152, 154) of the waveguide 105 and can each be configured to receive an output of the electrical power transmitted through different ones of the leads 120. In such a configuration, the electrical power, and hence heating, is substantially limited to the portion of the waveguide 105 that is in-between the electrical grounding points at the input and output ends 152, 154 (e.g., in the central region 150). Some embodiments of such configurations have a phase shifting efficiency of about 80 mW/π, e.g., about 80 mW of input electrical power can achieve a 180 degree phase shift in light transmitted through the waveguide 105.

In some cases, as depicted in FIGS. 1A and 3, the input or output can be transmitted through pairs of leads 120 that individually contact branching structures 140-142 that are located on opposite sides of the same portion of the waveguide 105. Such configuration help reduce the electrical resistance between the leads 120 and the waveguide 105.

FIG. 1B shows a plan view of an alternative embodiment of the device 100 and waveguide 105. The plan view is analogous to the view presented in FIG. 1A and the same reference numbers are used to depict analogous features. In the embodiment of the device 100 depicted in FIG. 1B, the input of the electrical power is transmitted from one end 154 to the opposite end 152 of the waveguide 105. For instance, the waveguide 105 and leads 120 are configured such that branching structures 141, 142 contact the leads 120 at the ends 152, 154 of the waveguide 105. In some cases, to prevent the leakage of electrical power to other components in the device, end portions 160, 162 of waveguide 105 are configured to have less electrically conductivity than other portions of the waveguide. For instance, in some cases portions 160, 162 of the waveguide (e.g., the upper cladding layer 220, FIG. 2) are implanted with dopants (e.g., p-type dopants) to decrease the conductivity of the implanted portions 160, 162.

One skilled in the art, in view of the present disclosure, would understand that the waveguide 105 and leads 120 could have other configurations. Examples of some configurations, similar to that depicted in FIG. 1B, are presented in U.S. Pat. Nos. 6,658,174 and 6,832,011, which are both incorporated by reference in their entirety, and which, in contrast to the present disclosure, used metal layers as heating elements.

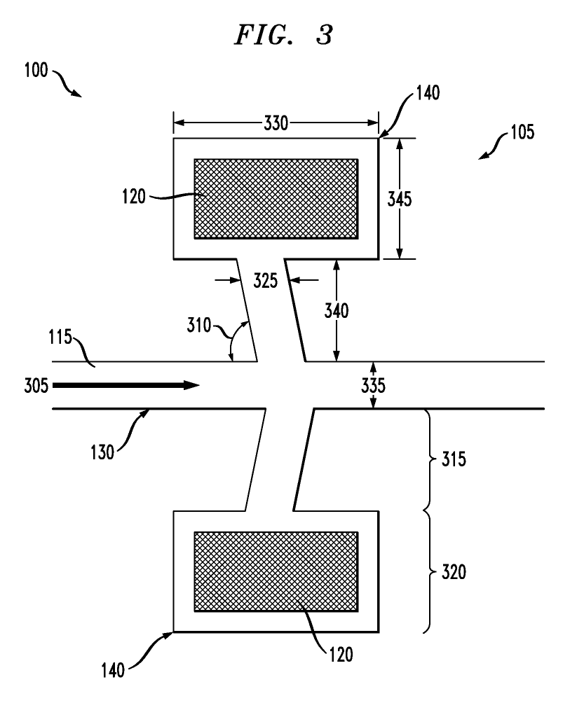

FIG. 4 shows a plan view of the waveguide 105 depicted in FIG. 1A, but at a lower degree of magnification so that certain additional features of the device 100 can be depicted. The waveguide 105 can include: an input waveguide 410 configured transmit an incoming light 305; first and second waveguide arms 420, 425 that are configured to receive first and second split light beams 430, 435 divided from the incoming light 305; and an output waveguide 440 configured to receive an output light 445 combined from the first and second light beams 430, 435 after passage through the first and second waveguide arms 420, 425. As illustrated, the waveguides 410, 420, 425, 440 can have different widths (e.g., width 335 in FIG. 3) from each other, although in some cases two or more of the waveguides 410, 420, 425, 440 have substantially the same widths. Additionally, the direction of incoming light 305 could be in the opposite direction to that depicted.

The cladding layer 115 for at least one the input waveguide 410, first and second waveguide arms 420, 425, or output waveguide 440, contact one or more of the leads 120. In some cases, each one of these waveguides 410, 420, 425, 440 contact different ones of the leads 120. For instance, an end 450 of the input waveguide 410 that is nearest to the first and second waveguide arms 420, 425, could contact leads 120. An end 452 of the output waveguide 440 that is nearest to the first and second waveguide arms 420, 425, could contact different leads 120. Central regions 150 of the first and second waveguide arms 420, 425 could contact still different leads 120. Contact between the waveguides 410, 420, 425, 440 and leads 120 can be facilitated through the use of branching structures 140-142 such as discussed above in the context of FIGS. 1A-3.

As further illustrated in FIG. 4, the device 100 can further include an input coupler 460 optically connected to an end 450 of the input waveguide 410 and input ends 462, 464 of the first and second waveguide arms 420, 425. The input coupler is configured to divide the incoming light 305 into the first and second light beams 430, 435. The device 100 can further include an output coupler 470 optically connected to output ends 472, 474 of the first and second waveguide arms 420, 425 and an end 452 of the output waveguide 440. The output coupler 470 is configured to combine the first and second light beams 430, 435 to form the output light 445. Embodiments of the input and output couplers 460, 470 include multi-mode interference couplers. For some embodiments, the input coupler 460 can be a 1-by-2 coupler and the output coupler 470 can be a 2-by-2 coupler.

In some embodiments, the device 100 further includes a power source 125. The power source 125 is coupled to the leads 120 via conductive lines 122. In some embodiments, the power source 125 is not part of the device 100. The power source 125 is configured to send electrical power through the leads 120 and thereby control a refractive index of the cladding layer 115 by passing electrical power through the cladding layer 115. The electrical power used to control the refractive index can include one or more control voltage or a control current, such as further discussed in the above-cited U.S. Pat. Nos. 6,658,174 and 6,832,011. For instance, as depicted, the power source 125 can provide two separate controlling voltages (Vin1, Vin2) to each one of the waveguide arms 420, 425 such that phase adjustments in each of the arms 420, 425 is independently controlled.

As further illustrated in FIG. 2, the device 100 can further include an insulating layer 230 that covers the waveguide 105. For instance, a silicon oxide insulating layer 230 can be deposited over the device 100 such that the waveguide (including its component waveguides 410, 420, 425, 440, FIG. 4) is entirely covered. The leads 120 can pass through openings in the insulating layer 230.

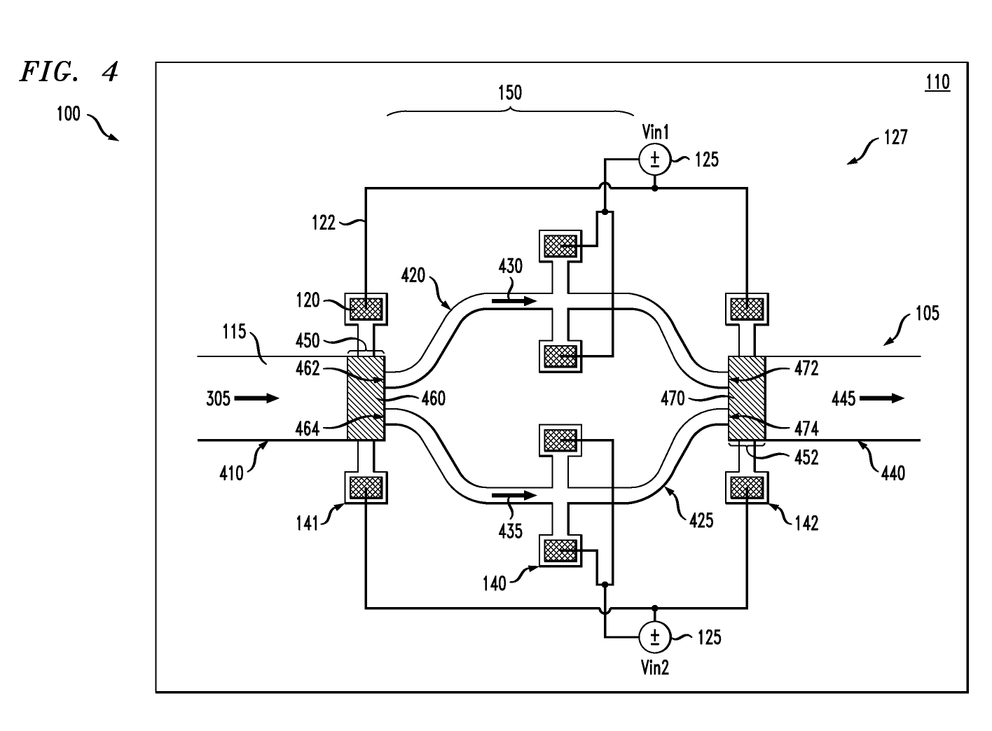

Another embodiment is a method of using the above-described devices. FIG. 5 presents a flow diagram showing selected steps of an example method of using an example device such as discussed in the context of FIGS. 1A-4.

With continuing reference to FIG. 5, the method comprises a step 505 of optically phase switching an incoming light 305. Switching the incoming light 305 (step 505) includes a step 510 of transmitting a first part 430 of the incoming light 305 to a first waveguide arm 420 of a waveguide 105. Switching the incoming light 305 (step 505) also includes a step 515 of transmitting a remaining second part 435 of the incoming light 305 to a second waveguide arm 425 of the waveguide 105.

Switching the incoming light 305 (step 505) also includes a step 520 of passing electrical power through leads 120 that contact at least one of the first or second waveguide arms 420, 425. The electrical power causes a change in a refractive index of a cladding layer 115 in the at least one waveguide arms 420, 425 such that at least one of the first and second parts of light 430, 435 are phase-adjusted to be either substantially in-phase or substantially out-of-phase with each other (e.g., in- or out-of phase with the phase of light in the other arm).

Switching the incoming light 305 (step 505) also includes a step 525 of optically combining the phase-adjusted first and second parts of light 430, 435. As a result of the combining step 525, the first and second parts of light 430, 435 either constructively add or destructively cancel to produce an output light 445.

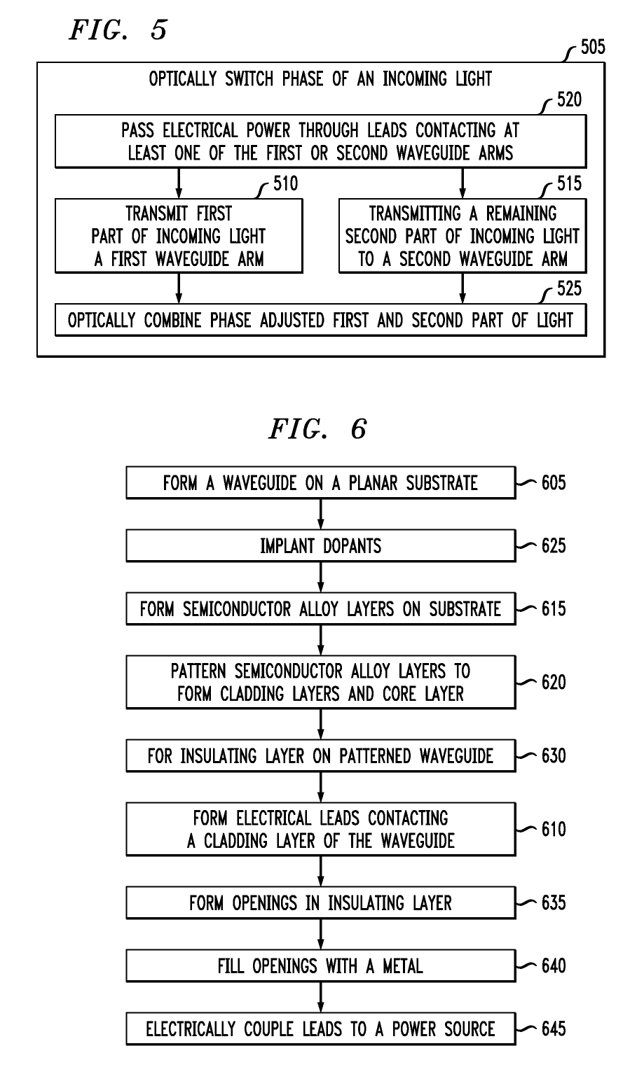

Another embodiment is a method of manufacturing the optical device. FIG. 6 presents a flow diagram showing selected steps of an example method of manufacture. With continuing reference to FIG. 2, the method comprises a step 605 of forming a waveguide 105 (e.g., a planar ridge waveguide) on a planar substrate 110, the waveguide 105 including a cladding layer 115. The method also comprises a step 610 of forming electrical leads 120 that directly contact the cladding layer 115. The leads 120 are formed so as to be coupleable to an electrical power source 125 for controlling a refractive index of the cladding layer 115 by passing electrical power through the cladding layer 115.

In some embodiments forming the waveguide in step 605 can further include a step 615 of forming semiconductor alloy layers on the planar substrate 110. For instance, step 615 can include successively depositing semiconductor alloy layers of InP, InGaAsP, InP, using procedures well known to those skilled in the art.

Forming the waveguide in step 605 can further include a step 620 of patterning the semiconductor alloy layers to form the lower cladding layer 210, core layer 215 and upper cladding layer 220 of the waveguide 105. In some cases, the pattering step 620 includes patterning portions of the semiconductor alloy layers to form branched structures 140.

In some embodiments, forming the waveguide in step 605 can further include a step 625 of implanting one or more alloy layer (or the patterned cladding layer 115 corresponding to the alloy layer) with dopants to alter the electrical conductivity of the cladding layer 115. For instance, in some cases step 625 includes implanting n-type dopants (e.g., arsenic or phosphorus) in a portion or the entire upper cladding layer 220 to increase the electrical conductivity of the implanted portion. For instance, in other cases, step 625 includes implanting p-type dopants (e.g., boron) into a portion of the upper cladding layer 220 so as to decrease the implanted portion's electrical conductivity.

In some embodiments, the method further includes a step 630 of forming an insulating layer 230 (e.g., thermally or chemical vapor deposited silicon oxide) on the patterned waveguide 105. In some embodiment, forming the electrical leads 120 in step 610 includes a step 635 of forming openings 235 in the insulating layer 230, and, a step 640 of filling the openings with a metal such as Ti, Pt, Au or alloyed combinations thereof. In some embodiments, the method further includes a step 645 of electrically coupling the leads 120 to an electrical power source 125 (FIG. 4). For instance, a metal layer (e.g., a copper layer) can be deposited on the insulating layer 230 and then patterned to form conductive lines 122 that electrically couple the leads 120 to the electrical power source 125.

Those skilled in the art would be familiar with the techniques that could be used to accomplish steps 610-640. One skilled in the art would also be familiar with additional processes to complete the fabrication of the optical device 100, including forming capacitors, conductive lines, transistors (not shown) on the planar substrate 110.

Although the embodiments have been described in detail, those of ordinary skill in the art should understand that they could make various changes, substitutions and alterations herein without departing from the scope of the disclosure.

What is claimed is:

1. An optical device, comprising:
a waveguide on a planar substrate, said waveguide including a semi-conductive cladding layer that contacts electrical leads which are coupleable to an electrical power source for controlling a refractive index of said cladding layer by passing electrical power through said cladding layer.

2. The device of claim 1, wherein said waveguide further includes a lower cladding layer, a core layer on said lower cladding layer and an upper cladding layer on said core layer, wherein said cladding layer includes at least one of said lower cladding layer or said upper cladding layer.

3. The device of claim 2, wherein said lower cladding layer and said upper cladding layer contact different ones of said leads.

4. The device of claim 1, wherein said waveguide includes a branching structure that include continuous portions of a lower cladding layer, a core layer and an upper cladding layer of said waveguide.

5. The device of claim 1, wherein said waveguide includes a branching structure that include a continuous portion of said cladding layer that contacts one of said leads.

6. The device of claim 5, wherein one or more said branching structure extends substantially normal to said waveguide.

7. The device of claim 5, wherein an exterior angle between said branching structure and a main body of said waveguide ranges from about 60 to less than about 90 degrees.

8. The device of claim 5, wherein said branching structure includes a first portion adjacent to said waveguide and a second portion that is continuously connected to said first portion and remote from said waveguide, wherein said first portion has a width that is less than a width of said second portion, and said second portion contacts one of said leads.

9. The device of claim 8, wherein said width of said first portion is less than or equal to a width of a main body of said waveguide.

10. The device of claim 8, wherein said first portion has a length that is at least about 5 times greater than said width of said first portion.

11. The device of claim 8, wherein said second portion has an area that is at least about 10 percent greater than an area of said contacting lead.

12. The device of claim 5, wherein a first one of said branching structures is centrally located along said waveguide and is configured to receive an input of said electrical power transmittable through one of said leads, and second and third ones of said branching structure are located on opposite ends of said waveguide and are each configured to receive an output of said electrical power transmittable through different ones of said leads.

13. The device of claim 1, wherein said waveguide includes:
an input waveguide configured transmit an incoming light;
first and second waveguide arms that are configured to receive first and second light beams divided from said incoming light;
an output waveguide configured to receive an output light combined from said first and second light beams after passage through said first and second waveguide arms, and wherein:
said cladding layer for one at least one of said input waveguide, said first and second waveguide arms, or said output waveguide, contact one or more of said leads.

14. The device of claim 13, wherein said each of said input waveguide, said first and second waveguide arms, or said output waveguide contact different ones of said leads.

15. The device of claim 13, wherein ends of said input waveguide and said output waveguide that are nearest said first and second waveguide arms each contact different ones of said leads, and central regions of said first and second waveguide arms each contact different ones of said leads.

16. The device of claim 13, further including:
an input coupler optically connected to an end of said input waveguide and input ends of said first and second waveguide arms, wherein said input coupler is configured to divide said incoming light into said first and second light beams; and
an output coupler optically connected to output ends of said first and second waveguide arms and an end of said output waveguide, wherein said output coupler is configured to combine said first and second light beams to form said output light.

17. The device of claim 1, further including:
an insulating layer that covers said waveguide, wherein said leads pass through openings in said insulating layer.

18. The device of claim 1, wherein cladding layer and said leads are part of a thermooptic switch of said optical device which is configured as a photonic integrated circuit.

19. A method of use, comprising:
optically switching a phase of an incoming light, including:
transmitting a first part of said incoming light to a first waveguide arm of a waveguide;
transmitting a remaining second part of said incoming light to a second waveguide arm of said waveguide;
passing electrical power through electrical leads that contact at least one of said first or second waveguide arms, thereby causing a change in a refractive index of a cladding layer of said at least one of said first or second waveguide arms such that one or both of said first and second parts of light are phase-adjusted to be either substantially in-phase or substantially out-of-phase with each other; and
optically combining said phase-adjusted first and second parts of light, wherein said first and second parts of light either constructively add or destructively cancel to produce an output light.

20. A method of manufacture, comprising:
forming a waveguide on a planar substrate, said waveguide including a cladding layer; and
forming electrical leads that directly contact said cladding layer, wherein said electrical leads are coupleable an electrical power source for controlling a refractive index of said cladding layer by passing electrical power through said cladding layer.
